(19) United States
(12) Patent Application Publication
(10) Pub. No.: US 2005/0102313 A1
(43) Pub. Date: May 12, 2005

(54) System for locating data elements within originating data sources

(75) Inventors: Jeffrey B. Levering, Harvard, MA (US); Sunil Garre, North Chelmsford, MA (US); Manish Kumar Vaish, Rohini (IN)

Correspondence Address: Randy J. Pritzker;Wolf, Greenfield & Sacks, P.C., 600 Atlantic Avenue, Boston, MA, 02210, US

(73) Assignee: NewRiver, Inc., Andover, MA (US)

(21) Appl. No.: 10/821,121

(22) Filed: Apr. 8, 2004

Related U.S. Application Data
(60) Provisional application No. 60/461,311, filed on Apr. 8, 2003.

(51) Int. Cl. G06F 17/00

(52) U.S. Cl. 707/102

(57) ABSTRACT

Computer-implemented methods and apparatus are provided for recording an indication of a source location at which a data element is stored. One method includes executing a set of programmed instructions to identify the source location comprising a portion of a data structure containing source information, wherein the portion contains the data element; and storing an indication of the source location in electronic file storage. The method may be semi-autimated, such that the programmed instructions preliminarily identify the data element, and a user is prompted to confirm that the identification is accurate. Using the indication of the source location, the data element may be retrieved and/or replicated from the source location to any of multiple output destinations.

### RELATED APPLICATIONS

This application claims priority under 35 U.S.C. § 119(e) to U.S. Provisional Application Ser. No. 60/461,311, entitled “SYSTEM FOR LOCATING DATA ELEMENTS WITHIN ORIGINATING DATA SOURCES,” filed on Apr. 8, 2003, which is herein incorporated by reference in its entirety.

### FIELD OF INVENTION

This invention relates to data access methods, and more particularly to providing a reference from a data element or portion in a data structure to a source data element or portion in an originating (source) data structure.

### BACKGROUND OF INVENTION

Securities exchanges and regulatory agencies require that issuers of securities make certain information available to a potential investor before a security is sold, and also upon completing the sale. Until recently, this information has been delivered to the investor, typically via services such as the U.S. Postal Service, Federal Express, or United Parcel Service. Recently, securities exchanges and regulatory agencies have begun allowing issuers to make information available to the investor in electronic form.

One facility for making investment information available is the Electronic Data Gathering, Analysis, and Retrieval (EDGAR) system, which is maintained by the United States Securities and Exchange Commission (“SEC”). The EDGAR system is a repository in which documents are stored which the SEC requires securities issuers to file by law. The EDGAR system is publicly accessible via the Internet and World Wide Web. The SEC makes filings available electronically to investors in order to increase the fairness of the markets, by ensuring that all investors have access to the same relevant information about securities listed by the exchanges.

One drawback with the EDGAR system is that the filings stored thereon are generally not sufficiently user-friendly for the “layman” investor. For example, EDGAR stores filings for a particular mutual fund in the name of the fund family, rather than in the fund name which is typically more recognizable to the investor. Each filing may include information for more than one fund, as well as amendments to earlier filings (there may be dozens, and typically more than fifty, amendments to filings for the typical fund). Moreover, the filing itself is organized in a form that can be difficult for the average investor to understand and navigate. As a result, an investor seeking a complete set of information for a particular security generally must review and reconcile many filings, for numerous different securities, which may not be designated in a way which is helpful to the investor.

One system which electronically compiles and reconciles securities filings so as to provide a complete, concise set of information on each security is described in commonly assigned U.S. Pat. No. 6,122,635 entitled “Mapping Compliance Information Into Usable Format” (incorporated herein by reference).

### SUMMARY OF INVENTION

Applicants have recognized that many users, in addition to desiring securities information to be organized into a more accessible form, also desire the ability to “back-track” from that form, such that they may view information as it was originally filed (i.e., before it was organized). Users may find this beneficial for any of numerous reasons. For example, a user may wish to verify that a data element (e.g., a portfolio fund manager's name) is accurate as presented (e.g., by a web site), so the user may wish to retrieve one of the “source” EDGAR filings in which the data element appeared. In addition, a user may wish to see information related to a particular data element. For example, a user inspecting a mutual fund's sales commission structure may wish to view a source EDGAR filing in which the commission structure was explained, to determine whether certain customers are not required to pay a commission to trade the fund.

Numerous systems aggregate and sanitize source data for presentation to the public. Indeed, many web sites are nothing more than collections of information which are gathered from various sources and compiled for presentation. Many news web sites, for example, gather information from press releases, field reports and other news sources, and compile this information for presentation according to their own unique styles. Inevitably, much of the information presented is taken from source material that a user may find useful, for verification, clarification or other purposes.

Applicants appreciate that one way of allowing a user to verify a data element presented by a system such as a web site is for the system to provide a hyperlink from the data element to the source information in which it originally appeared. However, using conventional technology, defining a reference from a data element to a location in source information, and encoding a hyperlink to represent the reference, entails manual effort. Specifically, using conventional technology, a user must scan the source information for data elements of interest, identify each data element and its location within the source information, define a reference to the location for each data element, and implement the references (e.g., as hyperlinks from a web site to the locations in the source information). For systems which compile large amounts of data from numerous heterogeneous sources, this process of establishing and encoding references to the respective sources of all data elements presented simply entails a prohibitively costly and labor-intensive effort. This is particularly true when the format and/or content of each piece of source information changes over time, as is the case with, for example, securities filings on EDGAR.

Accordingly, some embodiments of the invention provide a computer-implemented method of recording an indication of a source location at which a data element is stored, the method comprising acts of: (A) executing a set of programmed instructions to identify the source location, the source location comprising a portion of a data structure containing source information, the portion containing the data element; and (B) storing an indication of the source location in electronic file storage. The act (A) may further comprise executing a software application to identify the source location, wherein the software application employs a parameter defining a characteristic of the data element.

Other embodiments of the invention provide a computer-readable medium having instructions encoded thereon, which instructions, when executed by a computer, perform a method of recording an indication of a source location at which a data element is stored, the method comprising acts of: (A) executing a set of programmed instructions to identify the source location, the source location comprising a portion of a data structure containing source information, the portion containing the data element; and (B) storing an indication of the source location in electronic file storage.

Other embodiments of the invention provide a system for recording an indication of a source location at which a data element is stored, the system comprising: processing means for executing a set of programmed instructions to identify the source location, the source location comprising a portion of a data structure containing source information, the portion containing the data element; and storage means for storing an indication of the source location in electronic file storage.

### BRIEF DESCRIPTION OF DRAWINGS

In the drawings, in which the same reference characters refer to the same components throughout:

FIG. 1 is a block diagram of an exemplary computer system, with which embodiments of the invention may be implemented;

FIG. 2 is a block diagram of an exemplary computer memory, on which programmed instructions comprising illustrative embodiments of the invention may be stored;

FIG. 3 is a flowchart depicting a process for identifying and locating a data element within source information, according to some embodiments of the invention;

FIG. 4 is a block diagram depicting a system which may be employed to identify and locate a data element within source information, according to some embodiments of the invention;

FIGS. 5A-5B are representations of an exemplary graphical user interface (GUI) by means of which a user may confirm the identification of one or more data elements within source information, according to some embodiments of the invention;

FIG. 6 is a flowchart depicting a process for retrieving source information utilizing an indication of the location of a data element within the source information, according to some embodiments of the invention;

FIG. 7 is a block diagram of a system which may be employed to replicate a data element as it appears in source information to one or more output destinations in accordance with some embodiments of the invention;

FIG. 8 is a representation of an exemplary graphical user interface (GUI) by means of which a user may view output which includes a data element replicated from source information; and

FIG. 9 is a representation of an exemplary graphical user interface (GUI) by means of which a user may view source information which includes a data element.

### DETAILED DESCRIPTION

As described above, aspects of some embodiments of the invention are directed to creating a reference for one or more data elements to respective locations within items of source information in which the data elements appear. Source item may comprise, for example, a document filed by a securities issuer with the Securities and Exchange Commission (SEC).

In accordance with some embodiments, a method is given for creating a reference from a data element (e.g., in a data structure presented by a browser as a web page, such as a page which presents data in a user-friendly form as described above) to a location within source information. Of course, the method may be performed for a plurality of data elements, such that source information may be processed to identify locations within source information where each of a plurality of data elements is located.

Processing source information may implicate one or more automated, semi-automated and/or manual processes. Specifically, a location(s) may be preliminarily identified for each data element in an automated fashion, and a human user may be prompted via a graphical user interface (GUI) to confirm that each data element has been correctly identified. An indication of the source location for each data element may be stored in electronic file storage (e.g., a database). The electronic file storage may be queried via a GUI to retrieve the data element at the location in which it appears in the source information.

Because a data element may comprise information provided in any of numerous formats, a location within source information may be expressed in any of numerous ways. For example, a location may comprise a collection of alphanumeric characters which is identified with an offset from the start of a source file, a group of pixel(s) within a source image or figure, or any other suitable expression of location within source information.

According to other embodiments of the invention, a method is given for replicating one or more data elements from their respective locations within source information to one or more output destinations. This method may be useful to, for example, ensure that the data elements are presented in output as they were presented in source information. The method comprises identifying the source location(s) at which the data element(s) reside(s), storing an indication of the source location in electronic file storage, and, upon receiving a request to replicate the data element(s), accessing the indication of the source location from electronic file storage, employing the indication to retrieve the data element(s) from source information, and transferring the data element(s) to one or more destination locations. A destination location may comprise, for example, a location within a data file, such as an HTML page which is maintained by a web site.

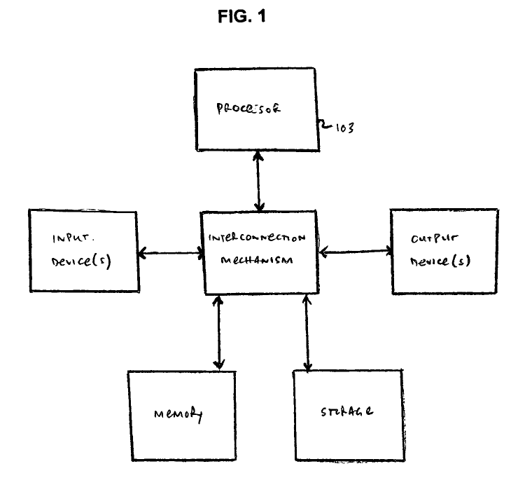

Embodiments of the invention may be implemented on any suitable computer system. For example, one or more computer systems may execute one or more hardware- or software-based facilities to recognize data elements within source information, and store a reference to the location of each data element within the source information, as well as the source information itself, in electronic file storage. In this respect, various aspects of the invention may be implemented on exemplary computer system 100, shown in FIG. 1. It should be appreciated that the system of FIG. 1 is not intended to be a limiting aspect of the invention, but rather provides an exemplary system for contextual reference.

Computer system 100 includes input device(s) 102, output device(s) 101, processor(s) 103, memory system(s) 104, and storage 106, all of which are coupled, directly or indirectly, via an interconnection mechanism 105, which may comprise one or more buses, switches, and/or networks. One or more input devices 102 receive input from a user or machine (e.g., a human operator, or programmed process), and one or more output devices 101 display or transmit information to a user or machine (e.g., a liquid crystal display). One or more processors 103 typically execute a computer program called an operating system (e.g., some version of Sun Solaris, Microsoft Windows®, or other suitable operating system) which controls the execution of other computer programs, and provides scheduling, input/output and other device control, accounting, compilation, storage assignment, data management, memory management, communication and data flow control. Collectively, the processor and operating system define the platform for which application programs in other computer program languages are written.

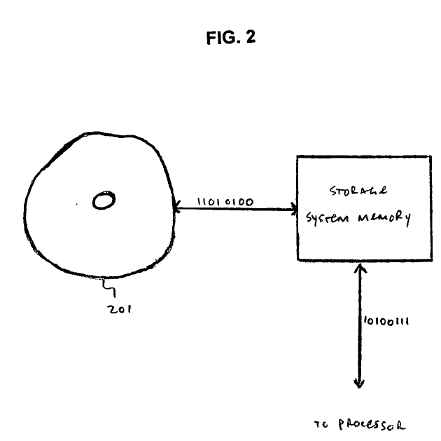

The processor(s) 103 may execute one or more programs (i.e., software) to implement various functions. These programs may be written in any type of computer programming language, including a procedural programming language, object-orientated programming language, macro language, other suitable language, or combination thereof. Programs may be stored in storage system 106. Storage system 106 may hold information on a volatile or non-volatile medium, and may be fixed or removable. Storage system 106 is shown in greater detail in FIG. 2.

Storage system 106 typically includes a computer-readable and computer-writeable non-volatile recording medium 201, on which signals are stored that define a computer program or information to be used by the program. The medium may, for example, be a disk, flash memory, or combination thereof. Typically, in operation, the processor 103 causes data to be read from the non-volatile recording medium 201 into a volatile memory 202 (e.g., a random access memory or RAM) that allows for faster access to the information by the processor 103 than does the medium 201. This memory 202 may be located in storage system 106, as shown in FIG. 2, or in memory system 104, as shown in FIG. 1. The processor 103 generally manipulates the data within the integrated circuit memory 104, 202 and then copies of the data to the medium 201 after processing is completed. A variety of mechanisms are known for managing data movement between the medium 201 and the integrated circuit memory element 104, 202, and the invention is not limited thereto. The invention is also not limited to a particular memory system 104 or storage system 106.

Aspects of the invention may be implemented, either individually or in combination, as one or more computer programs (i.e., a software applications) encoded as signals on a computer-readable medium (e.g., non-volatile recording medium 201, floppy disk, flash memory, or any other suitable medium). The program[s] may comprise instructions for access and execution by processor 103, such that the instructions, when executed by a computer, may instruct the computer to implement various aspects of the invention.

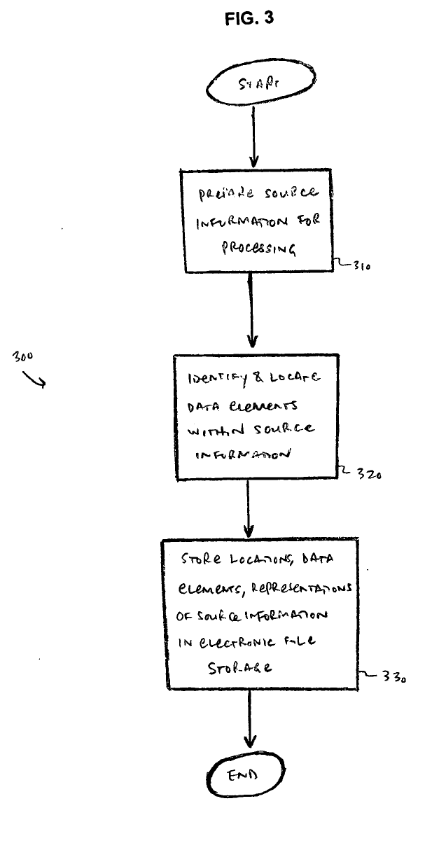

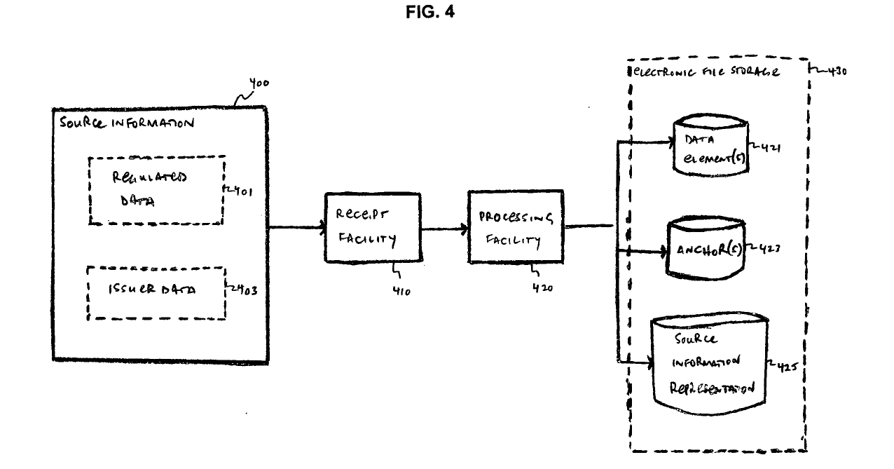

FIG. 3 depicts a process which may be implemented via one or more computer programs in accordance with aspects of the invention. Specifically, the process of FIG. 3 may represent acts for identifying the location of a data element within source information and storing an indication thereof in electronic file storage. The process of FIG. 3 may be performed, for example, by the system depicted in FIG. 4.

Upon the start of the process of FIG. 3, source information is received and prepared for processing in act 310. In some embodiments, source information 400 (FIG. 4) is received and prepared for processing by receipt facility 410.

Source information 400 may be provided in any form, such as in hard (e.g., paper) copy form, as signals encoded on a computer-readable medium, or in any other suitable form. Similarly, source information 100 may comprise any information. For example, source information 100 may comprise a mutual fund prospectus including words and figures representing information about the fund. In another example, source information 100 may comprise a data file including words and photographs.

In an embodiment wherein source information comprises a securities filing, source information 400 may include regulated data 401 and financial institution data 403. In some embodiments, regulated data 101 may comprise information which the issuer must provide within the filing in order to comply with SEC regulations. For example, regulated data 401 may comprise elements of a prospectus required by the SEC. Similarly, in some embodiments, financial institution data 403 may comprise information descriptive of the issuer. For example, financial institution data 403 may comprise the name, mailing address and other information on the fund company which issues a fund described by source information 400.

As indicated by the dotted lines shown in FIG. 4, source information 400 need not comprise either or both of regulated data 401 and financial institution data 403. In this respect, it should be appreciated that source information 400 need not comprise a securities filing, and may comprise any suitable collection of information. For example, source information 100 may comprise a news article, document, collection of information including one or more photographs, forms, or other collections of information. The invention is not limited to any particular implementation.

In some embodiments, receipt facility 410 begins the preparation of source information 400 for processing by reducing the data represented thereby to electronic form and loading it to memory (e.g., memory 201 shown in FIG. 2). As source information 400 may comprise information provided in any of numerous forms, receipt facility 410 may also take any of numerous forms, and may comprise one or more components implemented in software, hardware or a combination thereof. For example, in an embodiment wherein receipt facility 410 is configured to receive text provided on hard copy documents, receipt module 410 may comprise a hardware-based optical character recognition (OCR) facility configured to interpret information on the filings and produce data based on this information, and a software-based facility to load the data to memory for further processing. In another embodiment wherein receipt facility 410 is configured to process text provided in a file on a computer-readable medium, receipt module 410 may comprise one or more software-based modules designed to take source information 400 as input, and load the data it represents into memory for further processing.

In some embodiments, receipt facility 410 also performs a preliminary identification of source information 400. For example, in an embodiment wherein source information 400 comprises a security filing, receipt facility 410 may identify the type of filing, the issuer, the relevant security(ies), and/or other information. This may be performed in any suitable fashion. For example, receipt facility 410 may scan the source information 400, and compare data found therein with one or more data structures containing listings of known the types of filing, securities, issuers, and/or other data. Upon the preliminary identification of source information 400 by receipt facility 410, the act 310 completes.

Upon the completion of act 310, the process proceeds to act 320, wherein one or more specific data elements are located within the source information 400. In some embodiments, identification is performed by processing facility 420, which performs the identification and location using output received from receipt facility 410, as well as input provided by a human user. Specifically, in some embodiments, processing module 420 receives output from receipt facility 410 which defines, based on the preliminarily identification performed by receipt facility 410, the type of source information 400. Processing facility 420 uses this information to access one or more of a collection of data structures (e.g., flat files) which each contain one or more encoded parameters that are descriptive of data elements commonly found within the source information. Processing facility 420 utilizes the encoded parameters to locate the data elements within the source information. Once a data element has been located in the source information, processing facility 420 issues a prompt to a human user, via a graphical user interface (GUI), to confirm that the data element has been correctly identified.

In some embodiments, encoded parameters are provided as text within a data structure. One or more data structures may collectively represent a “taxonomy” for a specific type of source information interpreted by processing facility 420. Specifically, a taxonomy may define the characteristics of each of the data elements commonly found within the considered type of source information. A taxonomy may define data element characteristics for any type of source information. For example, a taxonomy may define characteristics of data elements within a type of securities filing from all issuers (e.g., all mutual fund prospectuses), all filings from a specific issuer, all filings from all issuers, or any other suitable grouping of source information. Further, more than one taxonomy may be applicable to a specific type of source information. The invention is not limited in this respect.

A taxonomy may include one or more descriptive characteristics for each data element to be identified within the source information. For example, a taxonomy for a mutual fund prospectus might provide parameters defining descriptive characteristics for a “portfolio manager” data element as it appears within a fund prospectus. For example, a parameter(s) for the portfolio manager data element may indicate that this data element is normally accompanied by the text “portfolio manager” within the source information. Any of numerous descriptive characteristics may be provided as a parameter for a data element within a taxonomy. For example, a parameter may indicate that a specific data element is normally accompanied by specific text (as with the example provided above), is normally found at a specific location within the source information (e.g., at the end of the document, or at the top of a page), normally receives a specific graphical treatment (e.g., is provided in a specific font, as an icon, and/or in a specific color), or otherwise conforms to a rule regarding its appearance or presence within source information.

A taxonomy may include more than one parameter for a specific data element. For example, a taxonomy for a fund prospectus may contain a first parameter for the portfolio manager data element which indicates that it is normally accompanied by the text “portfolio manager,” a second parameter which indicates that it is normally found at the top of the second page of the prospectus, and a third parameter which indicates that it is provided in a specific font. Further, a taxonomy may specify which of these parameters must be satisfied in order for the data element to be identified. For example, a taxonomy may specify that only the first and second of the above-listed parameters must be satisfied to identify the portfolio manager data element, that all three parameters must be satisfied, that only one must be satisfied, or any other suitable combination of these parameters. The invention is not limited to a particular implementation in this respect.

In one embodiment, processing facility 420 loads one or more taxonomies to memory and implements the encoded parameters therein as it processes the source information. In one embodiment, as the processing facility 420 reads the source information it compares the characteristics of the source information with characteristics represented in the parameters. As in the example provided above, the taxonomy for a specific type of source information may contain a parameter which indicates that the presence of the text “portfolio manager” within that source information indicates the presence of the portfolio manager data element. As the processing facility 420 reads the source information and compares its characteristics with those reflected by the parameters, upon encountering the text “portfolio manager” in the source information the processing facility may determine that the condition set forth by a parameter is satisfied, and identify the portfolio manager data element within the source information.

In some embodiments, a taxonomy may specify that a data element is accompanied by specific text or the equivalent of that text in any of several languages. For example, a taxonomy may specify that a portfolio manager data element is accompanied by the text “portfolio manager,” or the equivalent to “portfolio manager” in French, Spanish, Russian, Chinese, Japanese or any other language. Each of these equivalents to “portfolio manager” may simply be encoded as individual parameters within the taxonomy itself, or processing facility 420 may be configured to translate text into one or more other languages as needed. In this respect, it should be appreciated that text used to identify a data element need not be provided in English characters, and may be provided in Cyrillic, Arabic, Japanese, Chinese or any other suitable characters.

As discussed above, a taxonomy need not identify a data element by specifying text that normally accompanies the data element. A taxonomy may specify any attribute of a data element, such as its placement within source information, graphical treatment, or any other suitable attribute. Further, a taxonomy need not identify a data element using a single characteristic, as it may do so using a combination of characteristics, only a subset of which may need to be satisfied to identify the data element. As a result, processing facility 420 may perform one or more logical operations to evaluate a combination of characteristics to identify a data element. For example, a taxonomy may specify that two characteristics must be satisfied for a specific data element to be identified. As a result, processing facility 420 may scan the source information to determine that both characteristics are satisfied before identifying the data element. In another example, a taxonomy may specify that two of a group of three characteristics must be satisfied, in which case processing facility 420 may perform logical operations commensurate with this identification criteria. Any combination of logical operations, involving any combination of characteristics, may be performed to identify a data element, as the invention is not limited in this respect.

As discussed above, upon preliminarily identifying a data element in source information, processing facility 420 may prompt a human user to confirm that the data element has been correctly identified. The process by means of which a human user interacts with the process to confirm the identification of one or more data elements is described in further detail below. However, with respect to the function of a taxonomy, it should be noted that a response received from a human user as to whether a data element has been correctly identified may be used to update the taxonomy. For example, if a taxonomy fails to correctly identify a portfolio manager data element within source information, perhaps because the text “portfolio manager” accompanies information other than the portfolio manager data element, then the user's input indicating that the portfolio manager data element has not been correctly identified may be used to update the taxonomy. For example, a GUI may prompt the user to manually identify the portfolio manager data element within the source information, and prompt the user to provide one or more characteristics defining the correct portfolio manager data element. For example, the GUI may enable the user to specify that the correct portfolio manager data element is, in fact, accompanied by the text “portfolio manager” (e.g., it may be one of many components of the source information which is accompanied by that text) but also that the portfolio manager data element is found at the top of a page within the source information, is given a specific graphical treatment, or is identifiable in some other manner. In another example, the GUI may enable the user to specify that the portfolio manager data element is not accompanied by the text “portfolio manager,” but rather the text “investment manager.” In this manner, interaction with the user may allow the taxonomy to flexibly adapt over time in accordance to changes to source information, such as changes to format and/or content of source information initiated by securities issuers.

Even if a taxonomy correctly identifies a data element, a user's input may be useful for keeping the taxonomy in more specific conformance with the characteristics of source information. For example, if a taxonomy specifies that the portfolio manager data element is normally accompanied by the text “portfolio manager” but fails to specify that the data element also always appears in a specific location within the source information, processing facility 420 may cause the taxonomy to be updated to add the location characteristic. Further, processing facility 420 may indicate that the new characteristic is one which must be satisfied for the data element to be identified, or may be one of a combination of characteristics which might be satisfied and which is examined as part of a logical operation performed by processing facility 420, as described above. This manner of updating a taxonomy to more closely conform to the characteristics of source information may be performed automatically, or upon receiving confirmation by a user that the update should occur. For example, processing facility 420 may simply update the taxonomy over time upon observing characteristics of the data element as it appears in the source information, or may cause a user to be prompted (e.g., via a GUI) as to whether an observed characteristic should be added to a taxonomy.

As discussed above, upon identifying one or more data elements, processing module 420 may cause a user to be prompted to confirm that the identification is correct or provide further input to identify a data elements. The prompt may be presented to the user via a GUI, such as one provided by a software application executing on a personal computer or other suitable device. For example, processing facility 420 may cause a software application on a GUI to display a portion of source information 400 to a user, so that the user may provide input on the identification of one or more specific data elements.

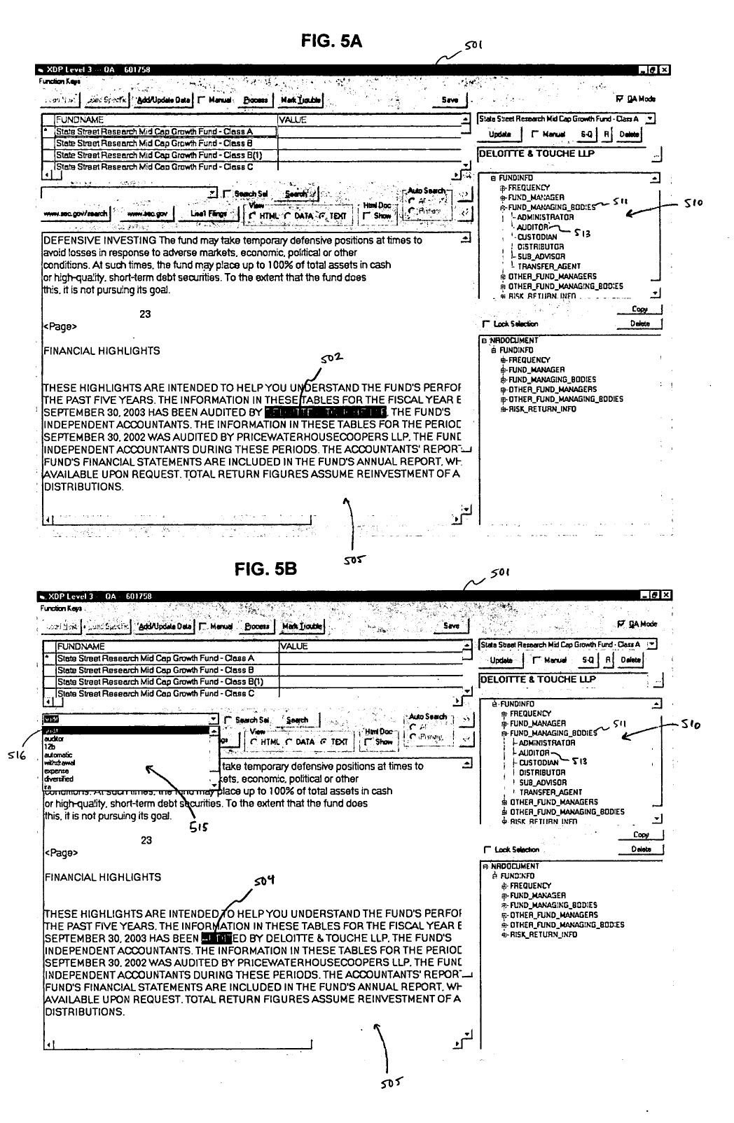

An exemplary GUI 501, by means of which a user may confirm the identification of one or more data elements within source information, is shown in FIGS. 5A-5B. GUI 501 includes several portions, including portions 505 and 510. Portion 505 displays source information 400 (which, in the example shown, is a prospectus for a mutual fund). More specifically, portion 505 displays the segment of source information 400 that fits in the display area.

Portion 510 displays a list representing some of the data elements which are to be identified within source information 400. In the example shown, the list is provided as a tree structure, such that the grouping 511 (“fund managing bodies”) may be expanded, as shown, to display the individual list members in the grouping. Included in the grouping is list member 511, representing the “auditor” data element. In this example, the auditor data element identifies the auditor of the mutual fund.

Portion 505 displays in highlighted form a text segment 502 (i.e., the text “Deloitte & Touche”) which has been preliminarily identified by processing facility 420 as the auditor data element. Assuming that the text segment 502 has been correctly identified by processing facility 420 as the auditor data element, the user may confirm this identification in any of numerous ways. For example, the user may simply select another member of the list shown in portion 510, to confirm the identification of a data element represented by the other list member.

If text segment 502 had been incorrectly identified as the auditor data element, the software application which renders GUI 501 for the user may assist a human user in identifying the true data element in several ways. One exemplary technique for assisting the user is shown in FIG. 5B. In FIG. 5B, drop-down list 515 contains a collection of terms which may be commonly associated with, found in close proximity to, or otherwise related to a text segment in source information 400 which represents the auditor data element.

A user may select any of the terms in drop-down list 515 in order to search for that term in source information 400. The terms may be supplied by, for example, one or more taxonomies, such that the software application which displays GUI 501 may access one or more data structures comprising the taxonomy(ies) to provide the terms shown in drop-down list 515.

In FIG. 5B, the user has selected term 516 (“audit”) from drop-down list 515. This term may be selected, for example, because it is commonly found in close proximity to the text segment that represents the auditor data element within source information 400. Upon selecting the element 516, the software application that displays GUI 501 may search for text within source information 400 that matches the term, such that the segment 504 is identified. In the exampel shown, the segment 504 is highlighted within portion 505, although it may be identified in any suitable fashion. Identifying text which matches the term may enable the user to identify the text segment which represents the auditor data element within the source information 400 displayed in portion 505.

It should be appreciated that the identification of data elements in source information need not occur in semi-automated fashion as described above. For example, identification of data elements may occur in a completely automated fashion, such that one or more taxonomies facilitate the identification of data elements, and this identification is not confirmed via interaction with a human user. In another example, a combination of automated and semi-automated techniques may be employed, such that an automated portion identifies some data elements without human intervention (e.g., elements which may be identified in a straightforward fashion) and a semi-automated portion employs human interaction to identify other data elements. In this respect, the extent to which the process involves human intervention may be dictated in part by the form and/or content of the source information, whether the arrangement of the source information has changed since the previous time it was processed, and whether the source information is provided in electronic form. For example, if a company issues a filing in a layout different from the layout in which it issued a previous filing, a greater level of human intervention may be required to identify the location in which one or more data elements are stored.

In some embodiments, once a data element is identified and its location within the source information is defined, an indication of this location (along with other information) is stored in electronic file storage so that subsequent retrieval may be facilitated (as is described below). In the embodiment depicted in FIG. 4, this indication of the location of the data element is denoted as anchor 423. In some embodiments, an anchor 423 is created for a data element by processing facility 420.

As discussed above, anchor 423 may express the location of a data element within source information in any of numerous ways. For example, a location may be expressed as a beginning data character (i.e., in an alphanumeric or text file containing the source information) for the data element and a quantity of characters over which the data element extends. In another example, a location may be expressed as a section of a page, such as might be provided by an HTML hyperlink containing a “#” section reference. In yet another example, a location may be expressed as a collection of pixels in an image file, such that the collection of pixels defines a portion of the image. In still another example, an anchor may not specify a particular location within source information, but may simply specify the source information in its entirety. Any suitable manner of expressing a location at which a data element appears within source informaton may be employed, as the invention is not limited in this respect. When the location of the data element within the source information is completed, the act 320 completes.

Upon the completion of the act 320, the process proceeds to act 330, wherein the anchor 423, together with a corresponding data element 421 and a representation of source information 425, is stored in electronic file storage 430. The representation of source information 425 may comprise, for example, source information 400 in electronic form, as created by receipt facility 410 (e.g., if source information 400 was provided in hard copy form). The representation of source information 425 may alternatively comprise a copy of source information 400, if it was provided in electronic form to receipt facility 410.

In some embodiments, storing anchor 423, data element 421 and source information 425 in electronic file storage entails creating a logical association therebetween. A logical association may be established, for example, using conventional database technology. For example, if anchor 423, data element 421 and source information 425 are stored in relational database tables, a logical association may be established with a foreign key from one table entry to another, as is well-known in the art. A logical association may be established in any suitable manner.

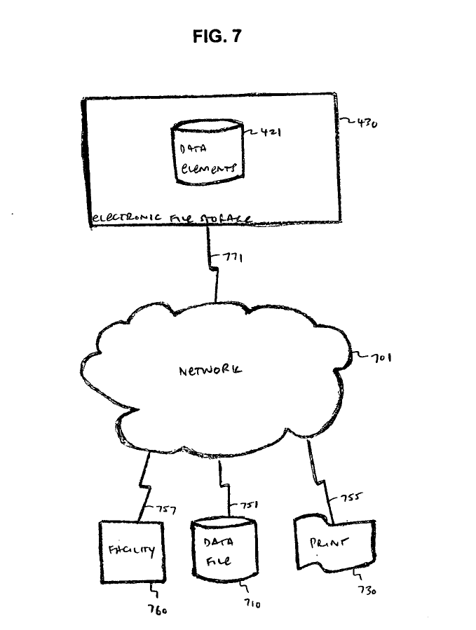

Once the logical association is established, anchor 423 may be used to retrieve source information 425 (or a portion thereof) at which a data element resides. (In some embodiments, the data element 421 stored in electronic file storage 430 is not employed in the retrieval process, but rather is used in a replication process described below with reference to FIG. 7). For example, a user viewing a data element on a GUI may retrieve, using corresponding anchor 423, the source information 425 (e.g., an original filing by an issuer with the SEC) in which the data element was originally supplied. An exemplary process for retrieving source information in this manner is described below.

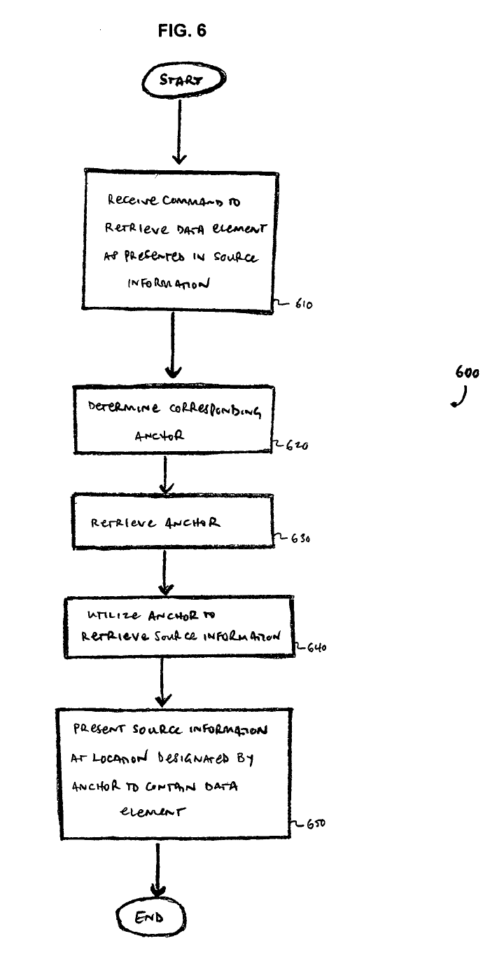

An exemplary process by means of which an anchor is used to retrieve a data element in source information is shown in FIG. 6. Upon the start of process 600, a command is received to display the data element as it is presented in source information. This command may be issued by, for example, a human user via a GUI. The GUI may, for example, display the data element in a manner which informs the user that he/she may retrieve and display the data element as it was presented in source information. This may be done in any of numerous ways, such as with a graphical emphasis on the data element (e.g., an underline) as it is presented on the GUI.

A command may be created and issued in any suitable fashion. In one example, a command may be issued upon a user's invocation of a hyperlink associated with the data element and presented via a GUI, such as a browser application executing on a device in communication with the electronic file storage in which the anchor and/or source information is stored (e.g., electronic file storage 430). Upon invocation of the hyperlink, the browser application may create and issue a command to the electronic file storage 430, via any suitable communication protocol. This description of an exemplary command should not be construed as limiting, as a command may be issued, generated or communicated in any suitable manner and using any suitable mechanism, and may take any suitable form. Further, the command may be issued to and from any suitable device. When the command is received by the device, the act 610 completes.

Upon the completion of the act 610, the process proceeds to act 620, wherein the command is processed to determine the anchor corresponding to the data element. In some embodiments, the hyperlink described above may be encoded to specify the anchor. In other embodiments, the anchor corresponding to the data element may be determined using a logical association between the anchor and data element, such as which may be provided by a database (as described above) or other data structure. The identification of the anchor corresponding to the data element may be performed in any suitable fashion, as the invention is not limited in this respect. Upon the identification of the anchor corresponding to the data element, the act 620 completes.

Upon the completion of act 620, the process proceeds to act 630, wherein the anchor is retrieved. This may be accomplished, for example, by executing an instruction specifying the anchor to retrieve a record representing the anchor from electronic file storage. Upon the retrieval of the anchor, the act 630 completes.

Upon the completion of the act 630, the process proceeds to the act 640, wherein the anchor is employed to retrieve source information, and more specifically the data element as presented in the source information. In some embodiments, the record representing the anchor retrieved in the act 630 may supply an identifier for another record which contains or refers to the source information. This other identifier may be included in an instruction which is executed to retrieve the record and access the source information. Upon the retrieval of the source information, the act 640 completes.

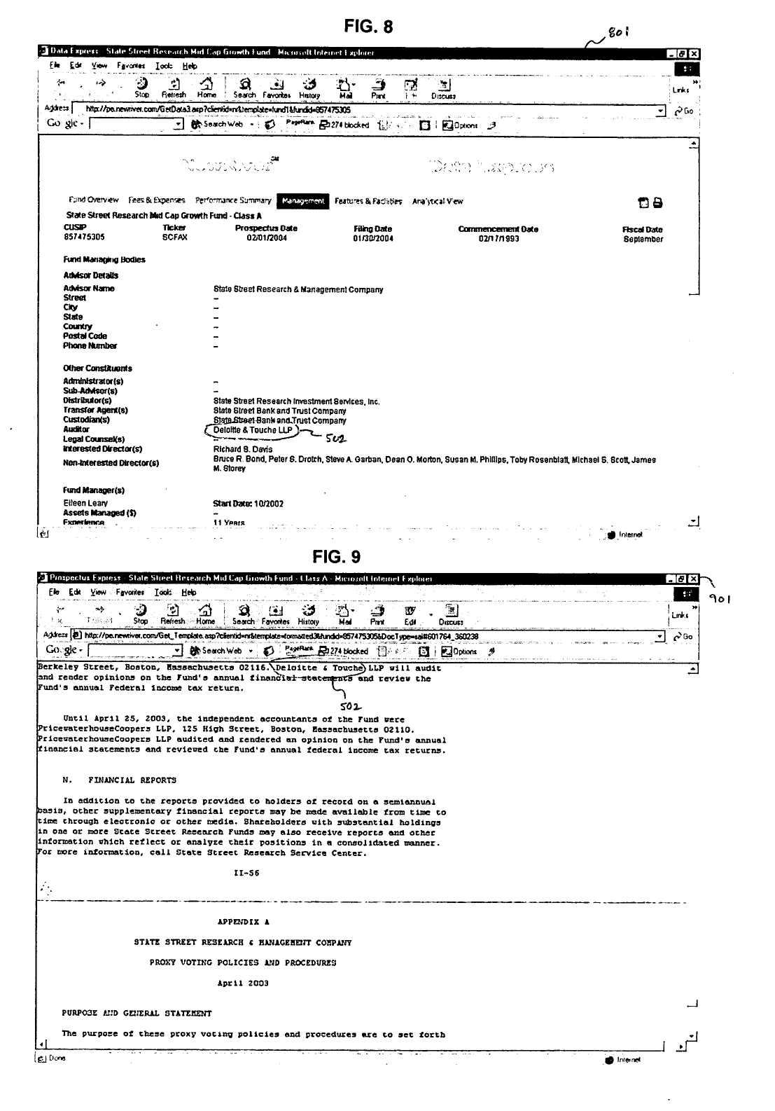

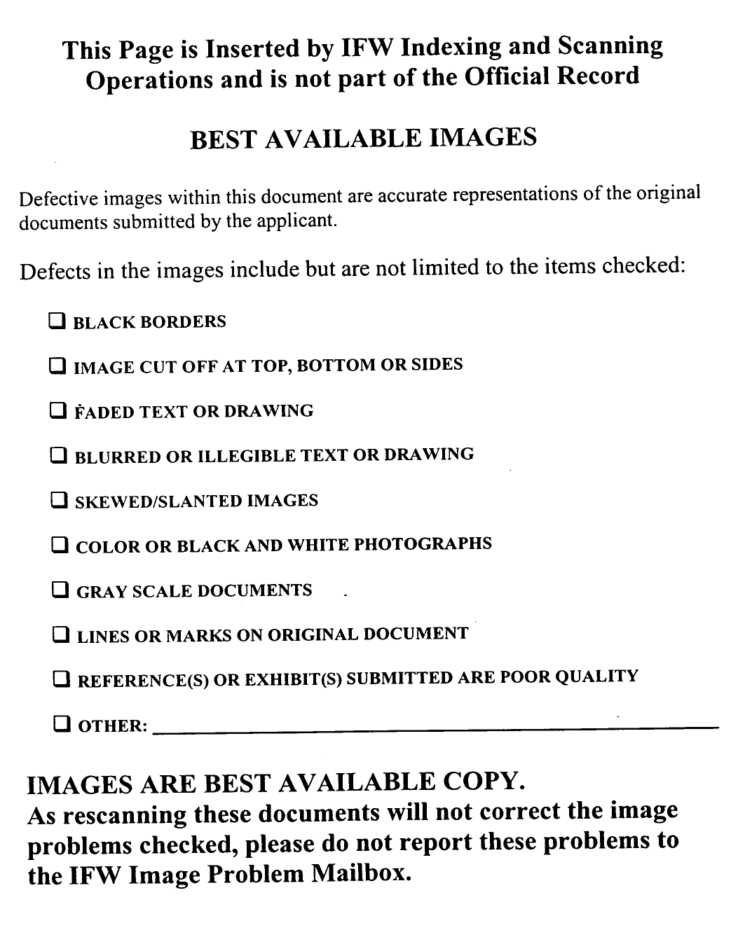

Upon the completion of act 640, the process proceeds to the act 650, wherein the source information, and more specifically the portion of the source information which includes the data element, is presented. In some embodiments, the electronic file storage may transmit the source information to a device which executes a GUI (e.g., the GUI which a user employed to issue the command received in the act 610), and the GUI may present the source information to the user. An exemplary GUI which displays source information to a user in this fashion is described below with reference to FIGS. 8 and 9. However, presentation may occur in any suitable fashion, as the invention is not limited to any particular implementation. Upon the completion of the act 650, the process completes.

It should be appreciated that the retrieval of source information in which a data element was originally presented need not entail retrieving the entire source information in which the data element resides. That is, a subset of the source information, such as a particular segment in which the data element appears, may be retrieved and/or presented. Retrieval of a subset of the source information may be accomplished in any of numerous ways. For example, source information may be split into segments before it is stored in electronic file storage 430. In another example, electronic file storage 430 may be configured to retrieve only the portion of source information in which the data element resides. Retrieval may be performed in any suitable fashion.

Referring again to FIG. 4, it should be appreciated that significant value exists in extracting specific data elements 421 directly from source information 400 with minimal (or no) human intervention, such as according to the process described with reference to FIG. 3. Specifically, minimizing human involvement in the extraction of data from source information may minimize human error, such that data elements 421, as presented in output, more accurately reflect data in the source information than if the data elements had been extracted manually. In some embodiments, then, data elements 421 may be replicated from electronic file storage 430 to one or more output destinations, to increase the accuracy of the data presented thereby. For example, data elements 421 may be replicated from electronic file storage 430 to a system which compiles and reconciles securities filings so as to provide a complete, concise set of information on each security (such as the system described in commonly assigned U.S. Pat. No. 6,122,635, entitled “Mapping Compliance Information Into Usable Format”), so that users of the system may be assured that the data elements presented thereon have been accurately transferred from the source securities filings. An exemplary system for facilitating the replication of a data element is described below with reference to FIG. 7.

FIG. 7 depicts a network-based system for facilitating the replication of data elements 421 from electronic file storage 430 to one or more ouput destinations. Electronic file storage 430 is in communication with network 301, which may comprise any suitable computer network, such as a local area network (LAN), wide area network (WAN), wireless network, the Internet, or a combination thereof. Network 701 may employ any suitable communication protocol, or combination of protocols. Via network 701, electronic file storage 430 is in communication with facility 760, data file 710, and print output 730.

According to an exemplary replication technique, replication is initiated by facility 760, which may be an automated, semi-automated or manual facility for initiating the replication of data elements 421. For example, facility 760 may comprise one or more batch processes or on-line applications, which may execute automatically, be operated by a human user, or initiate a replication process in any other suitable fashion.

Facility 760 may issue a command to replicate a data element to data file 710 and print output 730. Data file 710 may comprise, for example, an HTML page maintained by a web site, which may be viewed by a device such as a personal computer, workstation, personal digital assistant (PDA), cellular phone, or other suitable device. Print output 730 may comprise, for example, a report issued to investors in a specific security. To replicate a data element 421 to these output destinations, facility 760 may issue a command specifying the considered data element 421 via connection 757, network 701, and connection 771 to electronic file storage 430. The electronic file storage 430 may process the command to retrieve the data element 421, and send the data element 421 to each of data file 710 and print output 760. Specifically, electronic file storage 430 may send the data element 421 to data file 710 via connection 771, network 701 and connection 751. Similarly, electronic file storage 430 may send the data element 421 to print output 730 via connection 771, network 701 and connection 755.

It should be appreciated that although a single data file 710 and print output 730 are shown in FIG. 7, a data element may be replicated to any number of output destinations, including those which are not depicted in FIG. 7. Further, if a destination location comprises a location within a data file, the data file need not be in the same format as the source information. If destination locations within more than one data file are specified, the data files need not comprise the same format as each other.

FIG. 8 depicts an exemplary form of output to which a data element may be replicated. Specifically, FIG. 8 depicts GUI 801, which, in this example, is displayed by a browser application executing on a personal computer. GUI 801, in the example shown, is an interface designed to present information on a mutual fund to an investor in a more user-friendly and accessible form than is provided by the EDGAR database, such as is described above. As such, GUI 801 presents information found within source information 400. More specifically, the information displayed by GUI 801 consists of data elements identified within source information 400 by processing facility 420, and confirmed by a user with the GUI 501 displayed in FIGS. 5A-5B. One example of a data element identified within source information 400 is the auditor data element 502, as displayed by GUI 501 (FIGS. 5A-5B).

Of course, output need not be presented by a browser application executing on a personal computer, as any suitable display and/or device may be employed. Further, the chosen output form (e.g., an interface, paper copy, other output, or combination thereof) may display any suitable number of data elements, in any suitable fashion.

As described above with reference to FIG. 6, a data element may be displayed on output in a manner which allows a user to retrieve the source information containing a data element, via the anchor associated with the data element. For example, GUI 801 may display data element 502 in a manner which indicates that corresponding source information may be retrieved. This indication may be provided by, for example, highlighting, underlining, presenting in a different color, or otherwise indicating that source information retrieval is possible.

In some embodiments, when a user provides an indication via an interface (e.g., GUI 801) that source information containing a data element should be retrieved, the application which displays the interface causes the process described with reference to FIG. 6 to be invoked to retrieve the source information using the anchor associated with the data element, and displays the source information to the user via a separate interface. For example, when a user employs a mouse to click on the auditor data element 502 on GUI 801, the browser application may cause the process of FIG. 6 to be invoked to retrieve the corresponding source information, and display the source information using GUI 901 (FIG. 9).

As shown in FIG. 9, GUI 901 may display a specific portion of source information which includes the data element 502, indicating that the anchor corresponding to the data element provided an association between the data alement and the specific portion of source information shown. The portion to be retrieved may be defined in any of numerous ways. For example, as discussed above, the anchor may define a specific character offset at which the data element is displayed, a document section in which the data element is contained, a group of pixels found in an image file, or any other suitable definition.

Those skilled in the art will recognize that the description above illustrates an integrated system by means of which individual data elements may be identified within source information, catalogued, and stored for easy retrieval on demand. As such, the system may be useful for archival and retrieval of not only investor data, but all types of heterogeneous source information, such as news articles, multimedia, scientific data, or other information.

Embodiments of the invention may be implemented in any of numerous ways. For example, the functionality discussed above can be implemented using hardware, software or a combination thereof. When implemented in software, the software code can be executed on any suitable processor, or collection of processors, whether provided in a single computer or distributed among multiple computers. In this respect, it should be appreciated that the functions discussed above can be distributed among multiple processors and/or systems. It should further be appreciated that any component or collection of components that perform the functions described herein can be generically considered as one or more controllers that control the functions discussed above. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories or a combination thereof.

It should be appreciated that one implementation of the embodiments of the present invention comprises at least one computer readable medium (e.g., computer memory, floppy disk, compact disk, tape, etc.) encoded with a computer program (i.e., a plurality of instructions) which, when executed on one or more processors, performs the above-discussed functions of the embodiments of the present invention. The computer readable medium can be transportable such that the programs stored thereon can be loaded onto any computer system resource to implement the aspects of the present invention discussed herein. In addition, it should be appreciated that the reference to a computer program which, when executed, performs the above-discussed functions is not limited to an application program running on a host computer. Rather, the term “computer program” is used herein in the generic sense to reference any type of computer code (e.g., software or microcode) that can be employed to program a processor to implement the above discussed aspects of the present invention.

Having described several embodiments of the invention in detail, various modifications and improvements will readily occur to those skilled in the art. Such modifications and improvements are intended to be within the spirit and scope of the invention. Accordingly, the foregoing description is by way of example only and is not intended as limiting. The invention is limited only as defined by the following claims and equivalents thereto.

1. A computer-implemented method of recording an indication of a source location at which a data element is stored, the method comprising acts of:
(A) executing a set of programmed instructions to identify the source location, the source location comprising a portion of a data structure containing source information, the portion containing the data element; and
(B) storing an indication of the source location in electronic file storage.

2. The method of claim 1, wherein the act (A) further comprises executing a software application to identify the source location, wherein the software application employs a parameter defining a characteristic of the data element.

3. The method of claim 2, wherein the parameter is provided in a data structure which is accessed by the software application.

4. The method of claim 2, wherein the characteristic comprises text which accompanies the data element within the source location.

5. The method of claim 2, wherein the characteristic comprises text which represents the data element.

6. The method of claim 1, wherein the set of programmed instructions identifies the source location by preliminarily identifying the source location, requesting input from a user as to whether the source location is preliminarily identified correctly, and processing the input to identify the source location.

7. The method of claim 6, wherein the act of processing the input further comprises updating the characteristic.

8. The method of claim 1, wherein the data structure comprises a plurality of characters including a first character, and the source location is identified by a number of characters from the first character.

9. The method of claim 8, wherein the first character is at the beginning of the data structure.

10. The method of claim 1, wherein the data structure comprises a plurality of lines of information including a first line of information, and the source location is identified by a number of lines from the first line of information.

11. The method of claim 10, wherein the first line of information is at the beginning of the data structure.

12. The method of claim 1, wherein the data structure comprises a plurality of pixels arranged in a grid containing rows and columns, and the source location is identified by a pixel found at an intersection of a row and a column.

13. The method of claim 1, further comprising acts of:
(C) receiving a request to retrieve the data element;
(D) in response to the request, identifying the indication of the source location;
(E) employing the indication of the source location to retrieve the data element from within the source information; and
(F) writing the data element to output.

14. The method of claim 13, wherein the act (D) further comprises identifying the indication of the source location by retrieving the indication of the source location from the electronic file storage.

15. The method of claim 13, wherein the act (C) further comprises receiving the request from a user via a graphical user interface (GUI).

16. The method of claim 13, wherein the act (F) further comprises writing the data element to an output data structure which is displayed via a GUI to a user.

17. The method of claim 16, wherein the output data structure is provided in a hypertext markup language (HTML) format.

18. A computer-readable medium having instructions encoded thereon, which instructions, when executed by a computer system, perform a method of recording an indication of a source location at which a data element is stored, the method comprising acts of:
(A) executing a set of programmed instructions to identify the source location, the source location comprising a portion of a data structure containing source information, the portion containing the data element; and
(B) storing an indication of the source location in electronic file storage.

19. The computer-readable medium of claim 18, wherein the act (A) further comprises executing a software application to identify the source location, wherein the software application employs a parameter defining a characteristic of the data element.

20. The computer-readable medium of claim 19, wherein the parameter is provided in a data structure which is accessed by the software application.

21. The computer-readable medium of claim 19, wherein the characteristic comprises text which accompanies the data element within the source location.

22. The computer-readable medium of claim 19, wherein the characteristic comprises text which represents the data element.

23. The computer-readable medium of claim 18, wherein the set of programmed instructions identifies the source location by preliminarily identifying the source location, requesting input from a user as to whether the source location is preliminarily identified correctly, and processing the input to identify the source location.

24. The computer-readable medium of claim 23, wherein the act of processing the input further comprises updating the characteristic.

25. The computer-readable medium of claim 18, wherein the data structure comprises a plurality of characters including a first character, and the source location is identified by a number of characters from the first character.

26. The computer-readable medium of claim 25, wherein the first character is at the beginning of the data structure.

27. The computer-readable medium of claim 18, wherein the data structure comprises a plurality of lines of information including a first line of information, and the source location is identified by a number of lines from the first line of information.

28. The computer-readable medium of claim 27, wherein the first line of information is at the beginning of the data structure.

29. The computer-readable medium of claim 18, wherein the data structure comprises a plurality of pixels arranged in a grid containing rows and columns, and the source location is identified by a pixel found at an intersection of a row and a column.

30. The computer-readable medium of claim 18, further comprising acts of:
(C) receiving a request to retrieve the data element;
(D) in response to the request, identifying the indication of the source location;
(E) employing the indication of the source location to retrieve the data element from within the source information; and
(F) writing the data element to output.

31. The computer-readable medium of claim 30, wherein the act (D) further comprises identifying the indication of the source location by retrieving the indication of the source location from the electronic file storage.

32. The computer-readable medium of claim 30, wherein the act (C) further comprises receiving the request from a user via a graphical user interface (GUI).

33. The computer-readable medium of claim 30, wherein the act (F) further comprises writing the data element to an output data structure which is displayed via a GUI to a user.

34. The computer-readable medium of claim 33, wherein the output data structure is provided in a hypertext markup language (HTML) format.

35. A system for recording an indication of a source location at which a data element is stored, comprising:
processing means for executing a set of programmed instructions to identify the source location, the source location comprising a portion of a data structure containing source information, the portion containing the data element; and
storage means for storing an indication of the source location in electronic file storage.

36. The system of claim 35, wherein the processing means further executes a software application to identify the source location, wherein the software application employs a parameter defining a characteristic of the data element.

37. The system of claim 36, wherein the parameter is provided in a data structure which is accessed by the software application.

38. The system of claim 36, wherein the characteristic comprises text which accompanies the data element within the source location.

39. The system of claim 36, wherein the characteristic comprises text which represents the data element.

40. The system of claim 35, wherein the set of programmed instructions identifies the source location by preliminarily identifying the source location, requesting input from a user as to whether the source location is preliminarily identified correctly, and processing the input to identify the source location.

41. The system of claim 40, wherein processing the input updates the characteristic.

42. The system of claim 35, wherein the data structure comprises a plurality of characters including a first character, and the source location is identified by a number of characters from the first character.

43. The system of claim 42, wherein the first character is at the beginning of the data structure.

44. The system of claim 35, wherein the data structure comprises a plurality of lines of information including a first line of information, and the source location is identified by a number of lines from the first line of information.

45. The system of claim 42, wherein the first line of information is at the beginning of the data structure.

46. The system of claim 35, wherein the data structure comprises a plurality of pixels arranged in a grid containing rows and columns, and the source location is identified by a pixel found at an intersection of a row and a column.

47. The system of claim 35, further comprising:
receipt means for receiving a request to retrieve the data element;
identification means for, in response to the request, identifying the indication of the source location;
retrieval means for employing the indication of the source location to retrieve the data element from within the source information; and
output means for writing the data element to output.

48. The system of claim 47, wherein the identification means further identifies the indication of the source location by retrieving the indication of the source location from the electronic file storage.

49. The system of claim 47, wherein the receipt means further receives the request from a user via a graphical user interface (GUI).

50. The system of claim 47, wherein the output means further writes the data element to an output data structure which is displayed via a GUI to a user.

51. The system of claim 50, wherein the output data structure is provided in a hypertext markup language (HTML) format.
